(19) United States
(12) Patent Application Publication
(10) Pub. No.: US 2026/0185848 A1
(43) Pub. Date: Jul. 2, 2026

(54) MAP GENERATING SYSTEM

(71) Applicant: TOYOTA JIDOSHA KABUSHIKI KAISHA, Toyota-shi (JP)

(72) Inventors: Yoshiki UEDA, Toyota-shi (JP); Osamu TANIAI, Toyota-shi (JP); Shiro ODA, Toyota-shi (JP)

(73) Assignee: TOYOTA JIDOSHA KABUSHIKI KAISHA, Toyota-shi (JP)

(21) Appl. No.: 19/414,440

(22) Filed: Dec. 10, 2025

(30) Foreign Application Priority Data
Dec. 27, 2024 (JP) 2024-231525

(51) Int. Cl. G01C 21/00

(52) U.S. Cl. CPC G01C 21/383; G01C 21/3841

(57) ABSTRACT

A map generating system according to the present disclosure inputs building data, which is image data including at least an internal structure of a building, and a request, into a visual language model. The visual language model is a model that takes image data and language data as input, and outputs at least one of image data and language data. The request includes a demand to generate first information that is information regarding at least one of part of the internal structure and an existing object included in the building data. The map generating system acquires output information that is output from the visual language model in response to the request, and generates map data related to the internal structure of the building based on the output information that is acquired.

### CROSS-REFERENCE TO RELATED APPLICATION

This application claims priority to Japanese Patent Application No. 2024-231525 filed on Dec. 27, 2024. The disclosure of the above-identified application, including the specification, drawings, and claims, is incorporated by reference herein in its entirety.

### BACKGROUND

### 1. Technical Field

The present disclosure relates to a map generating system.

### 2. Description of Related Art

Japanese Unexamined Patent Application Publication No. 2021-196487 (JP 2021-196487 A) describes a map conversion system that acquires a two-dimensional or three-dimensional map that defines routes over which moving bodies can move. This map conversion system acquires maps through simulation using own-position estimation, based on three-dimensional BIM data representing spaces in which internal structures and attribute information of structural objects have been processed in advance, and on predetermined individual information according to the type of moving body. Note that BIM is an abbreviation for Building Information Modeling.

### SUMMARY

However, the technology described in JP 2021-196487 A may not be able to obtain map information for areas and so forth in which autonomous moving bodies cannot move. Also, with the technology described in JP 2021-196487 A, information regarding detailed structures and objects not included in the data has to be obtained by manual input or by measuring while making rounds, which requires a great amount of man-hours. Accordingly, there is demand for development of technology that can easily generate map data including desired information that influence movement of autonomous moving bodies, for example, from image data of an internal structure of a building.

A map generating system according to the present disclosure includes inputting building data that is image data including at least an internal structure of a building, and a request containing a demand to generate first information that is information regarding at least one of part of the internal structure and an existing object included in the building data, into a visual language model that is a model that takes image data and language data as input and outputs at least one of image data and language data, acquiring output information that is output from the visual language model in response to the request, and generating map data relating to the internal structure of the building, based on the output information that is acquired.

According to the present disclosure, map data including desired information can be easily generated from image data of an internal structure of a building.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration example of a management system that uses map data generated by a map generating system according to an embodiment;

FIG. 2 is a block diagram illustrating a configuration example of the map generating system according to the embodiment;

FIG. 3 is a schematic diagram illustrating an example of map data of one floor in a facility, which is input to the map generating system in FIG. 2;

FIG. 4 is a diagram showing an example of a table of correlation between waypoint attributes and actions;

FIG. 5 is a schematic diagram illustrating an example of map data of one floor in the facility, which is output from the map generating system in FIG. 2 after inputting the map data in FIG. 3; and

FIG. 6 is a flowchart for describing an example of a map generating method according to the embodiment.

### DETAILED DESCRIPTION OF EMBODIMENTS

The present disclosure will be described below by way of an embodiment of the disclosure, but the disclosure according to the claims is not limited to the following embodiment. Also, not all of the configurations described in the embodiment are necessarily essential means for solving the problem.

### Embodiment

The map data generated by the map generating system according to the present embodiment (hereinafter referred to as the present system) can be used in a management system for managing autonomous moving bodies, for example, which will be described below.

### Schematic Configuration Example of Management System

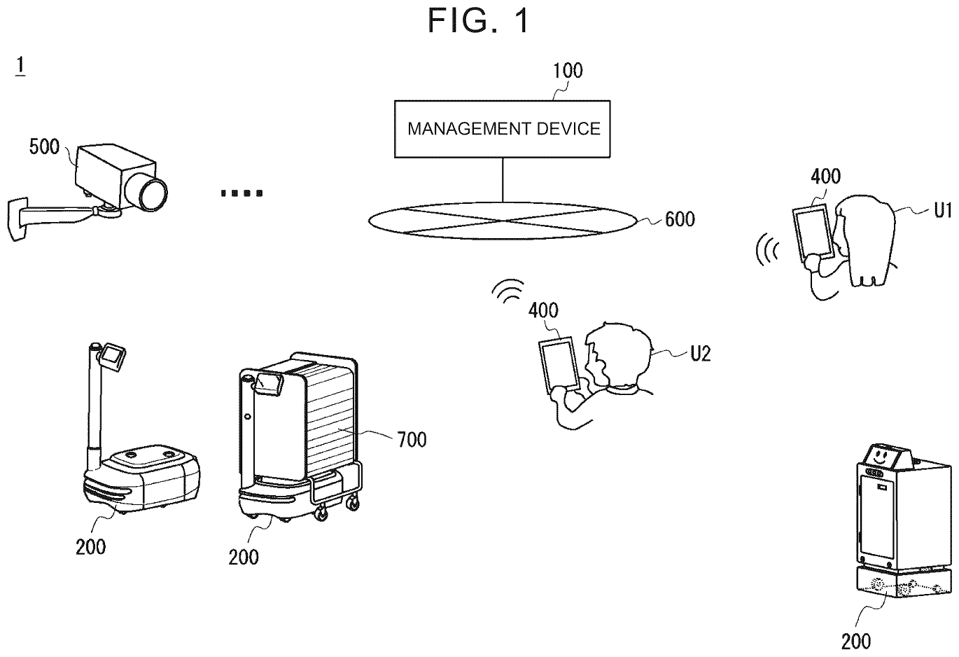

FIG. 1 is a schematic diagram illustrating a configuration of a management system 1. The management system 1 includes a management device 100, a robot 200, a camera 500, a network 600, a user terminal 400, and an accessory unit 700. The management system 1 is a system for managing one or a plurality of robots 200. The management device 100 manages passage and tasks of the one or multiple robots 200.

The robots 200 are autonomous moving bodies that carry out tasks such as transporting tasks and so forth. The robots 200 move autonomously in medical and welfare facilities such as hospitals, rehabilitation centers, nursing homes, elderly care facilities, and so forth. The robots 200 are used to transport medications, medical equipment, meals, tableware, medical records, supplies, samples, linens, people, and so forth. The object to be transported may be a person such as a patient or the like. Also, the management system 1 can also be used in commercial facilities and so forth, such as shopping malls and so forth. Each of the robots 200 has wheels, a chassis, a motor, a sensor, a battery, a controller, and so forth. At least one of the robots 200 is a different type of robot. The robots 200 may all be the same type of robot. Each of the robots 200 is assigned a unique identification number (ID). Although three robots 200 are illustrated in FIG. 1, the number of robots is not limited in particular, as long as there are one or more of the robots.

Further, at least one of the robots 200 may carry out a task other than the transporting tasks. Other tasks include cleaning tasks, security tasks, guiding tasks, and so forth. The robots 200 may use the accessory unit 700 to carry out a plurality of the tasks, such as cleaning, security, guiding, and so forth, or may carry out tasks alone. The robots 200 can carry out various types of tasks by the robots 200 being used in combination with the accessory unit 700, for example. The robots 200 may be equipped with different accessory units depending on the tasks. Replacing the accessory unit 700 enables the robots 200 to become multitasking robots that carry out multiple tasks.

In the case of a transporting task, the accessory unit 700 is a wheeled cart or wagon on which transported items are loaded. In the case of a cleaning task, the accessory unit 700 has a vacuum cleaner that sucks up dust and the like, which is different from that is illustrated. In the case of a security task, the accessory unit 700 has sensors such as LiDAR (registered trademark, the same applies hereinafter) a camera, and so forth, which is different from that is illustrated. In the following description, the robots 200 will be described as mainly carrying out transporting tasks.

A user U1 or a user U2 can use the user terminals 400 to place a task request, such as a transporting request for a transported item, or the like. The user terminals 400 are, for example, a tablet computer, a smartphone, or the like. The user terminals 400 may be any information processing device that is capable of wireless or wired communication.

The robots 200 and the user terminals 400 are connected to the management device 100 via the network 600. The network 600 is a wired or a wireless local area network (LAN), or a wide area network (WAN). Further, the management device 100 is connected to the network 600 via a wired or a wireless connection. Communication that is compliant with general-purpose communications standards such as, for example, Wi-Fi (registered trademark) or the like, can be used for the communication among devices.

Various types of signals transmitted from the user terminals 400 of the users U1 and U2 are first sent to the management device 100 via the network 600, and then transferred from the management device 100 to the robot 200 that is intended. Similarly, various types of signals transmitted from the robot 200 are first sent to the management device 100 via the network 600 and then transferred from the management device 100 to the user terminal 400 that is intended. The management device 100 is a server connected to each piece of equipment and collects data from each piece of equipment. Also, the management device 100 is not limited to being a single physical device, but rather may include multiple devices that perform distributed processing. Also, the management device 100 may be placed distributed among edge devices such as the robots 200 or the like. For example, part or all of the management system 1 may be installed in the robots 200.

Each of the robots 200 has a drive motor, wheels, a battery, and so forth. Further, the robot 200 has sensors such as a camera and LiDAR device or the like, and a computation processing unit such as a processor or the like. The robot 200 estimates its own position based on detection results of the sensors. The robot 200 autonomously moves along a route from a departure point to a destination point on a map, based on its own position. The departure point is the current position of the robot, and the destination point is a transportation destination of the transported item. Also, a route search may be performed using a transportation origin or the like of the transported item as a transit point. Note that the management device 100 may perform a route search from the departure point to the destination point, or the robot 200 may perform a route search.

The user terminal 400 and the robot 200 may exchange signals without going through the management device 100. For example, the user terminal 400 and the robot 200 may directly exchange signals via wireless communication. Also, the management device 100 may also collect data from the camera 500. The camera 500 is a surveillance camera, a security camera, or the like. Furthermore, the management device 100 may collect data from communication equipment and sensors that are omitted from illustration.

It will be assumed that a plurality of types of the robots 200 is used in a facility. The management device 100 assigns tasks to each of the robots 200. Each of the robots 200 may be equipped with an accessory unit 700 according to the task that is assigned thereto, so as to carry out the task. The tasks to be carried out by each of the three robots 200 may be input by the user U1 or the user U2, or may be scheduled in advance. For example, the user U1 or the like operates the user terminal 400 to place a task request. The user U1 or the like can input the type of task to be carried out. The user U1 or the like may input a region, a time slot, and so forth, in which the task is to be carried out. The management device 100 creates a schedule for the robot 200 to efficiently carry out tasks.

The user U1 or the user U2 may operate the user terminal 400 to request a transporting task. In this case, the user U1 or the user U2 inputs information regarding the transported item. Further, the user U1 or the user U2 may input arrival schedule information indicating the expected arrival time of the transported item. The management device 100 assigns a robot to carry out the transporting task based on expected arrival time information. The management device 100 then transmits a control signal for the robot to carry out the task. The control signal may include the route to the destination point, transported item information indicating the transported item, and so forth.

In such an overall configuration, the elements of the management system 1 can be distributed among the robots 200, the user terminals 400, and the management device 100, so as to construct the management system 1 as a whole. Also, the management system can be constructed by assembling all the essential elements for realizing transporting of the transported item into a single device.

The management device 100 includes a server computer or the like, and performs computation for controlling and managing the robots 200. The management device 100 can be implemented as a device capable of executing programs, such as a central processing unit (CPU) or the like of a computer, for example. The functions described below can also be realized by a program. The management device 100 manages each of the robots 200 based on map data stored therein, the transported item ID of the transported item, and the robot ID of the robot 200.

For example, the management device 100 manages schedules for the robots 200 such that the robots 200 can efficiently carry out tasks. For example, upon receiving a task request from the user terminal 400 or the like, the management device 100 selects one robot 200 from the robots 200, and instructs this robot 200 to carry out the task. Alternatively, the management device 100 instructs the robot 200 which of the accessory units 700 to use.

The map data used by the management system 1 may have waypoints set in association with positions or areas on the map, for example. Attributes may be set to the waypoints. At least one of an action to be taken by a moving body, and traveling section information that sets whether the moving body can pass or priority thereof, may be set to the map data or waypoints, in accordance with the waypoints or attributes thereof.

The map data is data of a map showing a floor map (also simply referred to as map) of a facility. This map data may include information regarding traveling-restricted areas, waypoints, and so forth. Also, the map data does not have to be a floor map of the entire facility, and may be data of a map that includes just a portion of a region in which a service is scheduled to be performed. Each of the robots 200 refers to the map data and autonomously travels to the destination point thereof.

The map data is data that is generated by the present system. The map data may be generated based on building data such as, for example, architectural drawings data of the facility, image data acquired by a camera installed inside the facility, measurement results data from a ranging sensor or the like, or data that is a combination of a plurality of these. The architectural drawings data may be image data obtained by scanning paper architectural drawings, CAD data, BIM data, or image data thereof in PDF (registered trademark, the same applies hereinafter) format. CAD is short for computer-aided design, and PDF is short for Portable Document Format. The measurement results data of the ranging sensor is an example of image data acquired by a sensor-equipped robot 200 or some other robot or person moving inside a building. The ranging sensor may be, for example, a LiDAR (registered trademark, the same applies hereinafter) device, a depth sensor, a stereo camera, a radar device, or a combination of a plurality of these. The map data is not limited to two-dimensional map data, and may be three-dimensional map data. When the ranging sensor is a LiDAR device, the measurement results data that forms the basis of the map data is two-dimensional point cloud data or three-dimensional point cloud data acquired using the LiDAR device, for example.

### Configuration Example of Present System

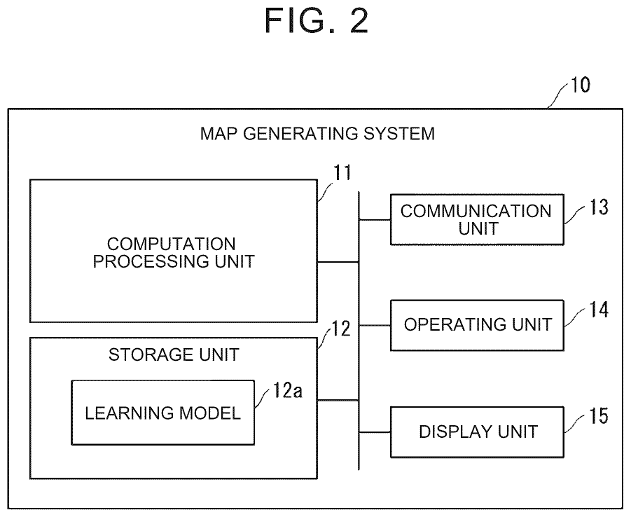

The present system for generating the above-described map data will be described with reference to FIG. 2. FIG. 2 is a block diagram illustrating a map generating system 10, which is a configuration example of the present system.

The map generating system 10 can be made up of a computer, and includes an computation processing unit 11 made up of a processor, memory, and so forth, a storage unit 12 made up of a storage device, a communication unit 13 that performs external communication, an operating unit 14 that accepts user operations, and a display unit 15 that displays information. The communication unit 13 includes a communication interface. Note that the map generating system 10 can also be constructed as a distributed system in which part of the functions are distributed across a plurality of devices.

The storage unit 12 stores a learning model 12a in an accessible state by the computation processing unit 11. The learning model 12a is an example of a trained model that has been subjected to machine learning and includes at least a visual-language model (VLM). The type of VLM is irrelevant. In an arrangement in which the learning model 12a includes a machine learning model other than a VLM, the model can be, for example, a model that performs pre-processing, intermediate processing, or post-processing of the VLM, and it is sufficient for algorithms and so forth thereof to be anything that can work in collaboration with the VLM to perform processing in accordance with requests.

The map generating system 10 inputs the aforementioned building data, which is image data including at least the internal structure of the building, and a request for the building such as the facility or the like described above into the learning model 12a or the VLM included in the learning model 12a.

The VLM is a model that takes image data and language data as input and outputs at least one of image data and language data. The VLM may be a generative artificial intelligence (AI) such as Chat-GPT (registered trademark) or the like, but is not limited thereto. The building data may be, for example, various types of architectural drawing data mentioned above, image data acquired by the camera installed inside the facility, and so forth, or a plurality of types of data thereof, and may be referred to as “building drawing data”. The building data may also include measurement result data from a ranging sensor.

The request is a demand that can be accepted from the operating unit 14, and includes a demand to generate first information that is information regarding at least one of part of the internal structure and an existing object, included in the building data. The first information can be, for example, a predetermined keyword, a predetermined icon, or the like. The request may be a request that has been stored in advance in the storage unit 12, in which case the request is read and input to the VLM. More specifically, the request is as follows, for example. That is to say, “please read the internal structure and existing objects of the building included in the building data input at the same time, extract walls, passageways, passageways of a certain width or less, stairs, elevators, and objects that fall under being fixtures, and output map data in which waypoints, with attributes corresponding to these, are set”. This request may include definitions of the waypoints, and setting of waypoints that do not fall under these definitions may be demanded as well. Alternatively, the request may include definitions of the waypoints, and simply demand general waypoints be set.

The computation processing unit 11 of the map generating system 10 acquires the input building data and output information output from the VLM in response to the request, and generates map data relating to the internal structure of the building based on the acquired output information. It is sufficient for the output information to be information that indicates the same type of information as the first information, and it is sufficient to be information extracted from the building data in accordance with the first information. The output information can be, for example, part of the internal structure or an abbreviation of an existing object, and a keyword or icon handled by the management system 1 such as a type ID or the like. Part of the internal structure refers to a wall, an elevator, or the like, and will be referred to as “structural object” hereinafter. An existing object can refer to an object installed in a building. The output information includes position information indicating positions, such as coordinates and so forth, corresponding to the building data.

The computation processing unit 11 generates and outputs map data according to a request from the user, by adding output information to original building data or image data generated from the building data, or the like. The output destination may be an external device via the communication unit 13, may be the display unit 15, may be storage in the storage unit 12, or may be a combination thereof.

Image data generated from building data can be, for example, image data generated in accordance with a request that is input. The demand for generating image data may be a demand indicating how to process building data, such as, for example, deleting unnecessary lines, converting position information into map data in a format used by the management system 1, or the like. Also, instead of the demand for the generation of image data, or in addition to this demand, a demand may be made for generation of other types of data. For example, this demand may be a demand indicating a method of generating information, such as generating a database that associates coordinates indicating positions with explanatory text that describes the structural object or existing object thereat in the building data.

The map data that is generated may have, for example, keywords or icons relating to part of the internal structure or existing objects, serving as output information, imparted to or associated with the original building data or image data generated from the building data, or the like, based on position information.

Thus, the map data that is output may be map data that the robots 200 refer to in order to move, and the output information may be data that is set in association with positions on the map data. Here, setting in associated with the position may be imparting to position information such as coordinate information or the like, or updating of the position information set in the building data.

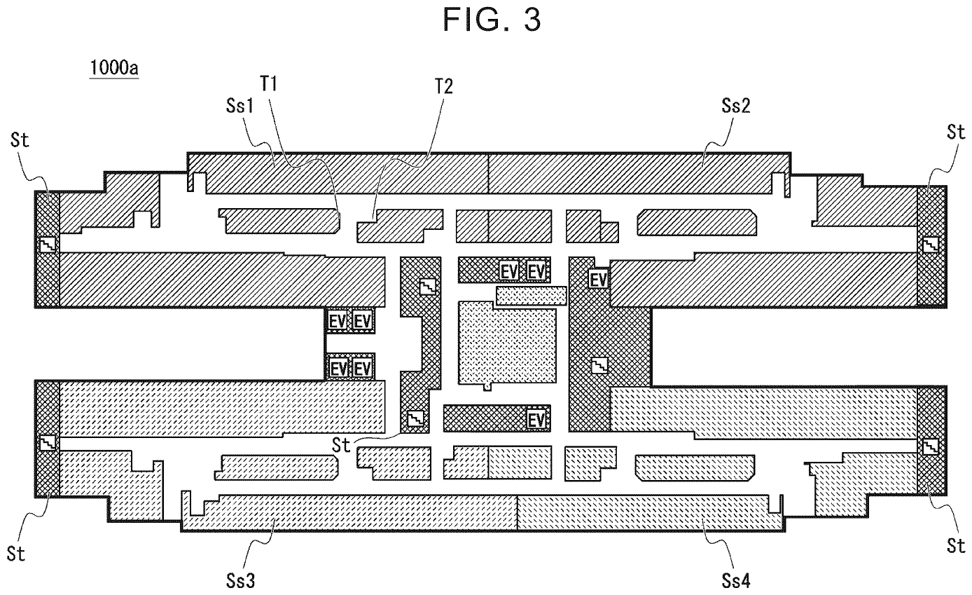

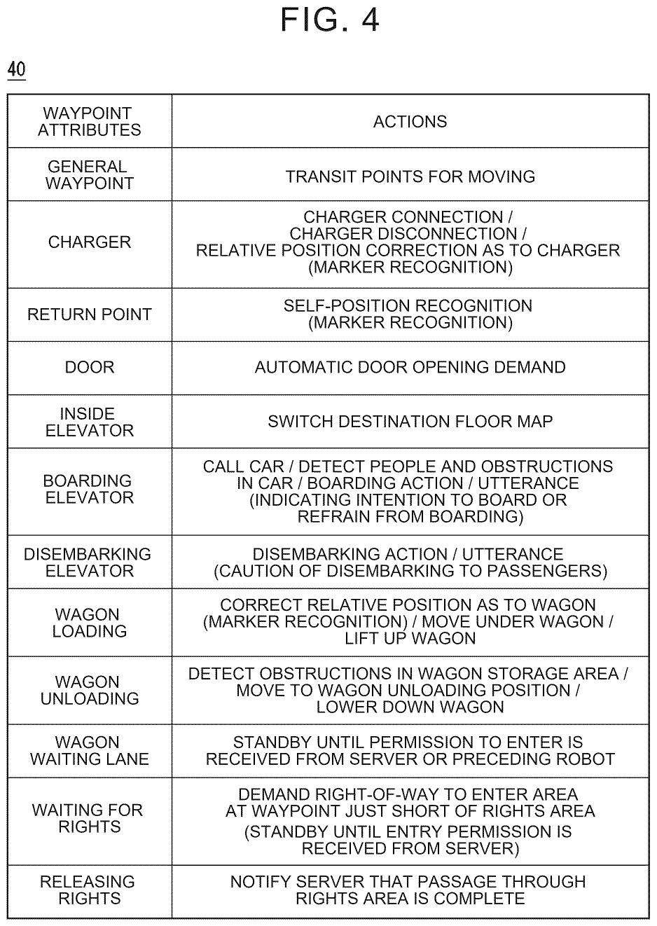

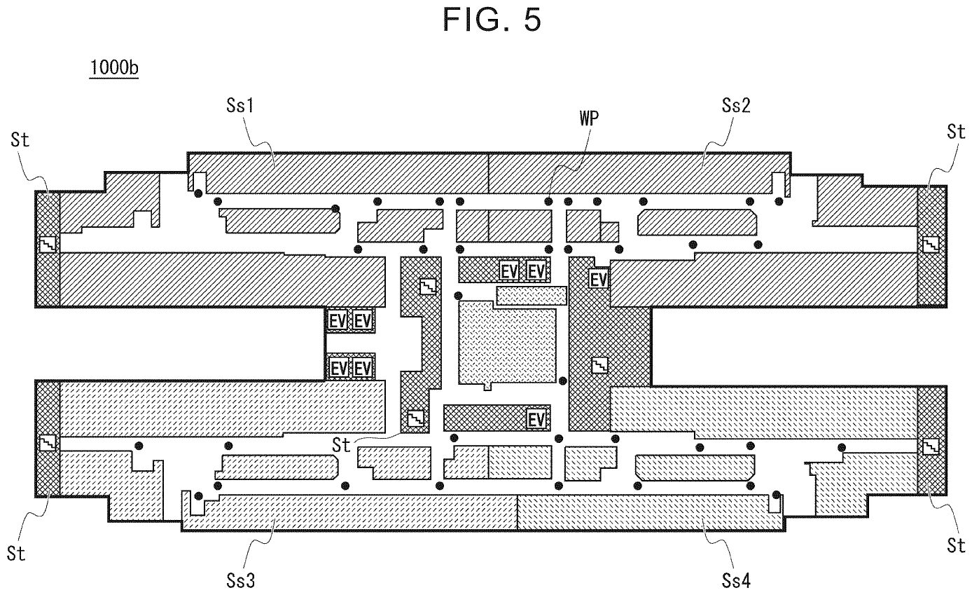

Next, an example of generating map data in the map generating system 10 will be described with reference to FIGS. 3 to 5. FIG. 3 is a schematic diagram illustrating an example of map data of one floor in a facility, which is input to the map generating system 10. FIG. 4 is a diagram showing an example of a table of correlation between waypoint attributes and actions. FIG. 5 is a schematic diagram illustrating an example of map data of one floor in the facility, which is output from the map generating system 10 in FIG. 2 after inputting the map data in FIG. 3.

As an example of building data input to the learning model 12a or the VLM included therein, architectural drawing data 1000a of one floor of the building exemplified in FIG. 3 will be described.

The architectural drawing data 1000a is drawing data that was used during construction, showing a certain floor in the facility. The facility that is exemplified is a hospital, and as illustrated in FIG. 3, on this floor there are structural objects such as staff stations Ss1, Ss2, Ss3, and Ss4, staircases St, elevators EV and so forth, and there are a plurality of fixtures T1 and T2, such as tables or shelves, and so on.

The first information included in the request, which is the information desired to be obtained as output information, can be information relating to at least one of structural objects and existing objects that influence movement of each of the robots 200 (hereinafter referred to as “second information”). The second information can include, for example, information regarding one or a plurality of the waypoints indicating transit points for the robot 200, narrow passageways, walls, areas where people are not allowed to pass, areas where people can pass, areas where the robot 200 is not allowed to pass, areas where the robot 200 can pass, obstructions, and so forth. Note that transit points may also be referred to as “relay points”.

The information regarding the waypoints can include a definition and description of the waypoint, and can include, for example, a definition or description of waypoint attributes (hereinafter referred to as “WP attributes”), which are attributes of the waypoints.

Now, waypoints will be described. Table 40 is a table describing the correspondence between the WP attributes set for waypoints and actions taken at these waypoints when the management system 1 is in operation. It should be noted that two or more attributes may be imparted to one waypoint. Specifically, in addition to general WP attributes, one or more other attributes may be provided.

General waypoints are waypoints that indicate transit points for moving. A transit point can be a departure point or a destination point. Examples of waypoint candidates include locations near doors, near narrow passageways, near elevators, and so forth, but are not limited thereto. General waypoints serve as transit points for moving in route planning. The robot 200 passes over the general waypoint and moves autonomously toward the next waypoint. For example, after each of the waypoints is set in the map data as a general waypoint, other WP attributes shown in Table 40 can be set, thereby overwriting or additionally setting the WP attributes. The WP attributes may be attributes corresponding to layout or types of rooms in the vicinity.

When a charger is set as a WP attribute, any one action of connecting to the charger, disconnecting from the charger, or correcting the relative position as to the charger by recognizing a marker on the charger, can be adopted. For example, when the remaining charge of the battery of the robot 200 falls to or below a certain value, the robot 200 moves to a waypoint of a charger as a destination point. When the robot 200 arrives at the waypoint of the charger, the robot 200 performs relative position correction. For example, a marker is attached to the charger, and the camera of the robot 200 captures an image of the marker in order to correct the relative position. The robot 200 is then connected to the charger and is charged. When charging is complete, the robot 200 is detached from the charger. The following WP attributes will be described more briefly.

When a return point is set as a WP attribute, an action can be adopted in which the robot 200 recognizes its own position thereof using markers marked at various locations within the facility. When a door is set as a WP attribute, an action for demanding opening of an automatic door can be adopted. When inside the elevator is set as a WP attribute, an action of switching the target floor map to a map inside the elevator (EV) can be adopted. When boarding elevator is set as the WP attribute, any one of the actions of calling an elevator car, detecting people or obstructions in the car, and boarding, or speaking to indicate an intention of boarding or refraining from boarding, can be adopted as an action. When disembarking elevator is set as a WP attribute, either a disembarking action or an utterance to warn of disembarking can be adopted as an action. When wagon loading is set as a WP attribute, any one action of correcting the relative position of the wagon by recognizing a marker on the wagon, moving under the wagon, and lifting up the wagon, can be adopted as an action. When wagon unloading is set as a WP attribute, any one of detecting an obstruction in a wagon storage area, moving to a wagon unloading position, or lowering down the wagon, can be adopted as an action. When wagon lane waiting is set as a WP attribute, an action of standby until permission to enter is received from the management device 100, which is the server, or a preceding robot 200, can be adopted. When waiting for rights is set as a WP attribute, an action can be adopted of demanding a right-of-way to an entry area at a waypoint just short of the rights area, and standing by until entry permission is received from the server. When releasing rights is set as a WP attribute, an action can be adopted to notify the server that passage through the rights area has been completed.

When a request including information regarding waypoints of the robot 200 as the first information is input, the computation processing unit 11 performs input thereof into the learning model 12a. The computation processing unit 11 then acquires the position information of each place corresponding to the waypoints in the architectural drawing data 1000a that has also been input as output information from the VLM, and generates map data in which the position information has been set.

The map data generated based on the architectural drawing data 1000a and the input of the request becomes, for example, map data 1000b illustrated in FIG. 5. The map data 1000b is map data that is generated when a request demanding information regarding a waypoint defined near a narrow passageway is input as the first information. The map data 1000b is imparted with waypoint WP information at each position indicated by a black dot. Of course, the information regarding the waypoints defined corresponding to each WP attribute exemplified in Table 40 can also be included as the first information. In this way, the map generating system 10 may input just a request that includes one type of information as the first information along with the building data, and output map data, or may input a request that includes multiple types of first information, and output map data.

Also, even when information other than that relating to waypoints is set as the first information, map data may be generated to which the information is imparted at positions corresponding to this information, in the same way. As a simpler example, when the first information includes information indicating walls, the generated map data will be imparted with information for each wall, indicating that each is a wall.

Alternatively, waypoint candidates may be positions that are set in association with locations sectioned by a segmentation algorithm such as a Voronoi dividing algorithm or the like. In this case, the computation processing unit 11 inputs the output information from the VLM to the segmentation algorithm provided downstream from the VLM in the learning model 12a. The computation processing unit 11 then executes segmentation processing based on the output information, sets waypoints at predetermined positions or the like in each of the divided areas, and outputs the map data after the waypoints have been set. For example, when first information including information, indicating walls, is input, the VLM may output the wall information as part or all of the output information, and use the output information as a keyword to execute processing using the segmentation algorithm. This processing is executed with respect to building data input to the VLM or map data output from the VLM, and information regarding divided areas, based on information indicating walls in the map data, can be included and output. By such processing, when setting waypoints, waypoints can be set as transit points at predetermined positions in each area, for example, at the middle of the area, on the boundary between adjacent areas, or the like. Also, including other types of information in addition to walls in the first information enables attributes or assumable actions to be set for waypoints in each area. The segmentation algorithm may also be a learning model that is subjected to machine learning, using the results of area division performed on various building data as training data.

Also, when rules indicating how area division is performed by the segmentation algorithm for various building data are known, then including those rules in the request as part or all of the definition of the waypoint or the description thereof as information regarding the waypoint enables waypoint information to be obtained as output information from the VLM even when the learning model 12a does not include the segmentation algorithm.

### Overview of Processing by Present System

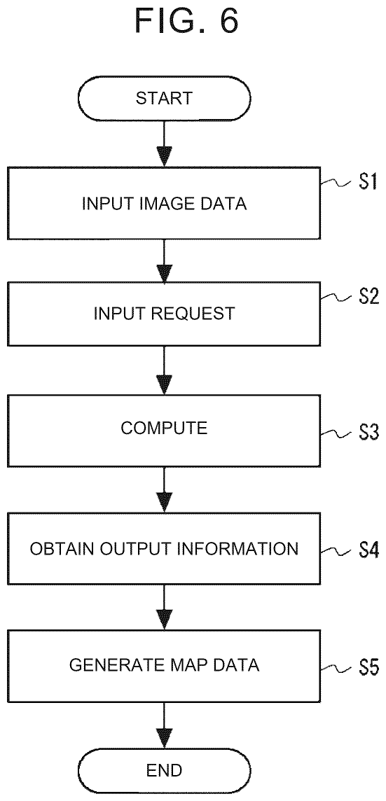

The present disclosure also includes a form of a map generating method, in which a computer generates the map data described above, as exemplified by processing of the map generating system 10. This map generating method will be briefly described using FIG. 6, but various application examples, such as those exemplified as the present system, can be applied. FIG. 6 is a flowchart for describing an example of the map generating method according to the present embodiment.

In this map generating method, first, the computer exemplified in the map generating system 10 inputs building data, which is image data, to the VLM (S1), and also inputs a request to the VLM (S2). The order of performing S1 and S2 is irrelevant, and may be performed simultaneously. Next, the computer executes computation in the VLM (S3) and obtains output information that is output from the VLM in response to the request (S4). Next, the computer generates map data relating to the internal structure of the building based on the output information that is acquired (S5), and the processing ends.

The present disclosure also includes a form of a program that causes a computer to execute processing in such a map generating method. Furthermore, part or all of the processing in the robot 200, the management device 100, and so forth described above, can also be realized as a program. Such a program can be stored and provided to a computer using types of various types of non-transitory computer-readable media. Non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), compact-disc read-only memory (CD-ROM), CD-R, CD-R/W, and semiconductor memory (e.g., mask ROM, programmable ROM (PROM), erasable PROM (EPROM), flash ROM, and random access memory (RAM)). The program may also be supplied to the computer by various types of transitory computer-readable media. Examples of transitory computer-readable media include electrical signals, optical signals, and electromagnetic waves. A transitory computer-readable medium can supply the program to the computer via a wired communication path such as an electric wire, an optical fiber, or the like, or via a wireless communication path.

### Effects of Present Embodiment

According to the present embodiment, map data including desired information that influences the movement of autonomous moving bodies, for example, can be easily generated from image data of an internal structure of a building without requiring a great number of man-hours. Also, according to the present embodiment, the VLM automatically generates information regarding the interior of the building, thereby enabling map data to be generated without involving movement of an autonomous moving body within a simulation environment, i.e., without being based on measurement result data. Thus, according to the present embodiment, regardless of whether the building data includes measurement result data, a situation will not occur in which map information cannot be obtained for areas and so forth in the simulation environment where an autonomous moving body cannot move. Even when the building data is made up only of measurement result data, map data can be output in which information such as waypoints is set to an extent that only minimally influences movement of the autonomous moving bodies according to the present embodiment. Also, according to the present embodiment, the VLM can automatically generate information regarding the interior of the building, also including information that cannot be directly read from data prepared in advance, such as BIM or the like, thereby reducing the effort required to acquire additional information regarding the interior of the building.

### Other Application Examples

Note that the present disclosure is not limited to the above-described embodiment, and can be modified as appropriate without departing from the spirit and scope thereof.

For example, the map data that is generated may be used for purposes other than movement of autonomous moving bodies such as the robots 200. In FIGS. 3 to 5, it is assumed that the input building data and the generated map data are two-dimensional, but may be three-dimensional data, but as described with respect to the map data. Three-dimensional map data can be used to set attributes such as ceilings, floors, and so forth, as waypoints, and can also set attributes such as, for example, ceilings with exhaust vents, ceilings of a certain height or lower, floors with guide lights, whether flooring material is a certain material, and so forth. Accordingly, for example, depending on the height of the robot 200, an action such as no entry allowed, or the like, can be set at a waypoint that has an attribute of a ceiling of a predetermined height or lower. Also, at waypoints that have the attribute of a floor with guide lights, actions such as no parking allowed, or the like, can be set. Also, the three-dimensional map data can also be used for operating autonomous flight vehicles, which are autonomous moving bodies that fly.

Also, while the learning model 12a or the LVM included therein has been described assuming being a trained model, this may also be a retrainable model. For example, the learning model 12a preferably includes, for example, an open source machine learning model such as RaG (Retrieval-Augmented Generation) or the like, as the VLM. This enables the computation processing unit 11 to update the learning model 12a based on the latest database. This database can be updated to yield more accurate output information.

What is claimed is:

1. A map generating system, comprising:
inputting building data that is image data including at least an internal structure of a building, and a request containing a demand to generate first information that is information regarding at least one of part of the internal structure and an existing object included in the building data, into a visual language model that is a model that takes image data and language data as input and outputs at least one of image data and language data;
acquiring output information that is output from the visual language model in response to the request; and
generating map data relating to the internal structure of the building, based on the output information that is acquired.

2. The map generating system according to claim 1, wherein the first information is information relating to at least one of part of the internal structure and an existing object that influences moving of a moving body.

3. The map generating system according to claim 2, wherein the first information includes information regarding a waypoint for the moving body.

4. The map generating system according to claim 1, wherein the map data is map data that the moving body references to move, and the output information is data that is set in association with a position on the map data.

5. The map generating system according to claim 1, wherein the building data is at least one of architectural drawing data of the building, image data acquired by a camera installed inside the building, and image data acquired by an autonomous moving body equipped with a sensor moving inside the building.
